(19) United States
(12) Patent Application Publication
(10) Pub. No.: US 2005/0236564 A1
(43) Pub. Date: Oct. 27, 2005

(54) Laser desorption mass spectrometer with uniform illumination of the sample

(75) Inventors: Craig A. Keller, Menlo Park, CA (US); Curtis Lomax, Sunnyvale, CA (US); Edward Perry Wallerstein, Pleasanton, CA (US); Timothy M. Montagne, Fremont, CA (US); Michael Youngquist, Palo Alto, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Ciphergen Biosystems, Inc., Fremont, CA (US)

(21) Appl. No.: 10/832,822

(22) Filed: Apr. 26, 2004

(51) Int. Cl. H01J 49/16

(52) U.S. Cl. 250/288

(57) ABSTRACT

Systems and methods for rastering a series of illumination pulses across the surface of a sample under investigation in a mass spectrometer system so as to create a two dimensional illumination pattern (raster pattern) on the sample. A probe interface that engages a probe is configured to translate the probe along a first direction, and a pulse deflection mechanism is configured to vary the pulse-probe intersect position along a second direction. A control system, implementing a rastering algorithm, provides control signals to the pulse deflection mechanism to adjust the pulse path and the probe translation mechanism to adjust the probe position so that each illumination pulse impinges on one of a plurality of addressable locations on the sample. The resulting raster pattern may cover the entire sample or one or more portions of the sample, depending on the spot size and the displacement distances for each pulse along the first and second directions. Ions desorbed from the sample by each pulse are detected, and a corresponding series of spectra are generated for each of the series of pulses. The spectrum resulting from each pulse may be combined with others to form a combined spectrum for the portion of the sample illuminated by the raster pattern.

### BACKGROUND OF THE INVENTION

The present invention relates generally to mass spectrometers, and in particular to laser desorption and ionization (LDI) mass spectrometers.

FIG. 1 illustrates components of a typical laser desorption and ionization time-of-flight (LDI-TOF) mass spectrometer. Briefly, the system comprises ion optics 20, which include a repeller 21, an extractor 22, a acceleration lens 23 and a detector 25. A mass filter 24 may be included. A sample 30 is applied to the surface of a probe 19. In MALDI, the sample is mixed with a matrix material that crystallizes on the probe surface. In SELDI, a matrix material can be applied to the sample after capture on the surface, or the probe can have energy absorbing molecules associated with the probe surface. A light pulse 31 is applied to sample 30 to thereby release or desorb ions. An electric field (extraction field) is set up between repeller 21, extractor 22, and acceleration lens 23, to thereby accelerate desorbed ions through the ion optics toward detector 25. For example, repeller 21 may be held at a potential of 30 kV, extractor 22 may be held at a potential of, for example, 15 kV, while acceleration lens 23 may be held at ground potential. In a pulsed ion extraction (PIE) system, the potential difference between the repeller 21, extractor 22 and acceleration lens 23 is typically pulsed based on the timing of the light pulses applied to the sample 30 on probe 19. For example, time-lag focusing may be implemented by providing a small time delay between application of a light pulse and creation of an extraction field. Timing of a light pulse may be determined by passing the light pulse 31 through a beam splitter 27 such that a portion of each pulse 31 activates a trigger photo diode 32.

In MALDI, for example, molecules of matrix material are desorbed with the analyte molecules from sample 30. Since the analyte molecules are the molecules of interest, mass filter 24 may be utilized to filter out the matrix molecules. Mass filter 24 typically comprises an entry plate and exit plate (not shown) and a deflector. Finally, the ions reach detector 25 and the time-of-flight in traveling to the detector is used to calculate a mass to charge ratio (m/z). The time the process started is known based on the timing of a laser pulse and/or the creation of the extraction field. A laser desorption/ionization, time-of-flight mass spectrometer (LDI-TOF-MS), as depicted in FIG. 1, could be used to perform Matrix-assisted Laser Desorption/Ionization (MALDI) and Surface-enhanced Laser Desorption/Ionization (SELDI) analysis.

In a typical LDI-TOF mass spectrometer, the light pulse applied to the sample may suffer from intensity non-uniformities that may create a fluence variation across the sample, thereby causing the desorption conditions across the laser-interrogated portion of the sample to vary. This can degrade the resolution of the mass measurement and increase intensity variations. Further, many such mass spectrometers only offer one (or none) dimension of sample translation, so that the interrogated portion of the sample is limited to the dimension of the laser spot, which may include intensity non-uniformities. As such, the quality of resulting mass spectra may be less than optimal.

It is therefore desirable to provide systems and methods to improve the quality of mass spectra generated by a laser desorption and ionization mass spectrometer. Such systems and methods should improve the uniformity of fluence delivered across the laser illuminated portion of a sample, and increase the fraction of the sample that can be effectively used in mass spectrometric analysis.

### BRIEF SUMMARY OF THE INVENTION

The present invention provides systems and methods that enhance the quality of mass spectra generated by LDI mass spectrometers. The quality of spectra generated is improved in certain aspects by enhancing figures of merit such as sensitivity, signal-to-noise ratio and resolution. The present invention, in one aspect, provides systems and methods that improve the uniformity of energy flux delivered across the illuminated portion of a sample. In another aspect, the present invention provides systems and methods that increase the fraction of the sample deposited on the probe that can be effectively used in mass spectrometric analysis.

According to an aspect of the present invention, a mass spectrometer device is provided that typically includes an illumination source that provides light pulses, and a probe interface configured to engage a probe so that the light pulses illuminate an illumination area on a sample presenting surface on the probe, wherein the probe interface includes a probe translation means for automatically translating an engaged probe such that the illumination area moves across the sample presenting surface along a first direction. The mass spectrometer device also typically includes a pulse directing means for directing the light pulses to the sample presenting surface and for automatically redirecting the light pulses across the sample presenting surface in a second direction, wherein the second direction is non-parallel to the first direction. In operation, the probe translation means and the pulse directing means operate to raster the illumination area in a two dimensional illumination pattern across the sample presenting surface.

According to another aspect of the present invention, a method is provided for illuminating a region of a sample in a mass spectrometer with light pulses. The method typically includes providing light pulses, providing a probe interface configured to engage a probe, and directing the light pulses towards a sample presenting surface on an engaged probe, wherein the light pulses illuminate an illumination area of the sample presenting surface. The method also typically includes forming a two dimensional illumination pattern on a region of the sample presenting surface by automatically translating the probe such that the illumination area moves across the sample presenting surface in a first direction, and automatically redirecting the light pulses in a second direction across the sample presenting surface, wherein the second direction is non-parallel to the first direction.

According to yet another aspect of the present invention, a mass spectrometer device is provided that typically includes an illumination source that provides light pulses, and a probe interface configured to engage a probe so that the light pulses illuminate an illumination area on a sample presenting surface on the probe, the probe interface further being configured to automatically translate an engaged probe responsive to a first control signal such that the illumination area moves across the sample presenting surface along a first direction. The mass spectrometer device also typically includes a pulse directing element configured to direct the light pulses to the sample presenting surface and to automatically redirect the light pulses along a second direction non-parallel to the first direction in response to a second control signal, and a control module configured to provide the first and second control signals so as to raster the illumination area in a two dimensional illumination pattern on a region of the sample presenting surface.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1 illustrates components of a typical laser desorption and ionization time-of-flight (LDI-TOF) mass spectrometer.

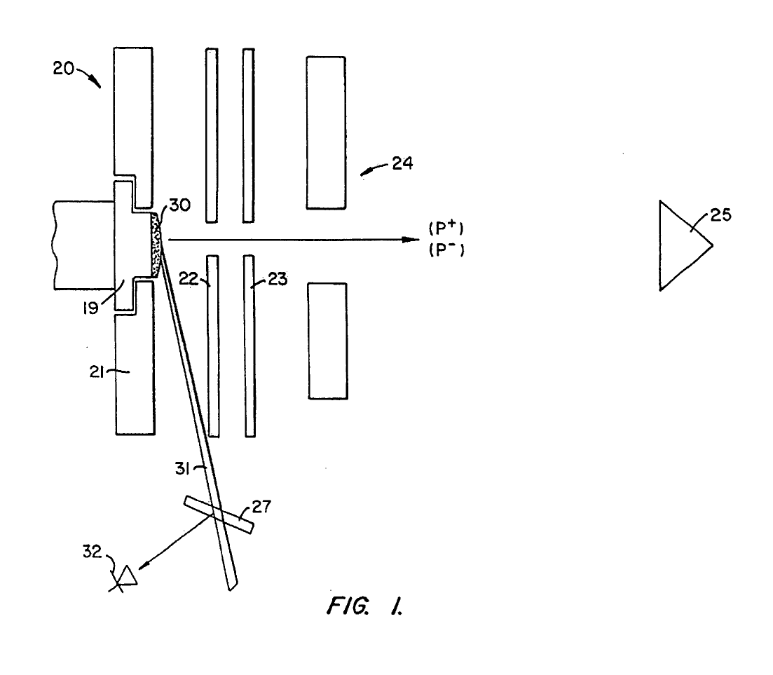

FIG. 2 illustrates components of a laser desorption and ionization time-of-flight (LDI-TOF) mass spectrometer according to one embodiment of the present invention.

FIG. 3 illustrates possible illumination patterns on the sample presenting surface of a probe according to one embodiment of the present invention.

FIG. 4 illustrates an example of a mask element that allows a more uniform intensity portion of a light pulse to pass while rejecting the remaining portion.

### DETAILED DESCRIPTION OF THE INVENTION

The present invention, in one embodiment, provides systems and methods for rastering a series of illumination pulses across the surface of a sample under investigation in a mass spectrometer system so as to create a two dimensional illumination pattern (raster pattern) on the sample. In one aspect, a probe interface that engages a probe is configured to translate the probe along a first direction, and a pulse deflection mechanism is configured to vary the pulse-probe intersect position along a second direction. A control system, implementing a rastering algorithm, provides control signals to the pulse deflection mechanism to adjust the pulse path and the probe translation mechanism to adjust the probe position so that each illumination pulse impinges on one of a plurality of addressable locations on the sample. In response to these control signals, a raster pattern is generated on the sample. As one simple example, the probe may be translated by a unit distance in the first direction and a series of pulses may be rastered across the second direction, and the probe then translated by another unit distance in the first direction and the pulses rastered again in the second direction. The resulting raster pattern may cover the entire sample or one or more portions of the sample, depending on the spot size and the displacement distances for each pulse along the first and second directions. Each addressable location may or may not overlap with other locations. Also, a raster pattern need not represent a square array as any desired pattern may be created with appropriate probe translations and pulse deflections

To improve the uniformity of energy delivered to a sample by each pulse, a mask element is provided in one embodiment to mask off a portion of each pulse and allow a portion of the pulse with a substantially uniform intensity profile to pass to the sample. Focusing optics are also provided to adjust the focus, and therefore the spot size, of the pulses on the sample. Ions desorbed from the sample by each pulse are detected and a corresponding spectrum is generated. The spectrum resulting from each pulse may be combined with others to form a combined spectrum for the portion of the sample illuminated by the raster pattern.

Advantageously, rastering the pulses in this manner extends the accessible region of the sample beyond the dimension of the laser spot itself, thereby maximizing the amount of sample that can be desorbed, ionized and detected. This can improve the signal-to-noise ratio (S/N) for peaks in the mass spectrum. Also, because rastering allows a small illumination spot to access a large sample area and because a small spot reduces the energy required to achieve the desired energy density at the sample, the laser and the optical system can be optimized for a flat intensity profile at the expense of the energy delivered to the sample. Further, the raster pattern can be optimized for the figures of merit most important to a particular application. For example, rastering in a wide pattern may maximize sample usage and lower the lower-limit-of-detection for a given analyte, while rastering in a narrow pattern may increase the fraction of ions passing through a small region of the ion optics, thereby minimizing variations in ion flight paths and maximizing the resolution of the instrument.

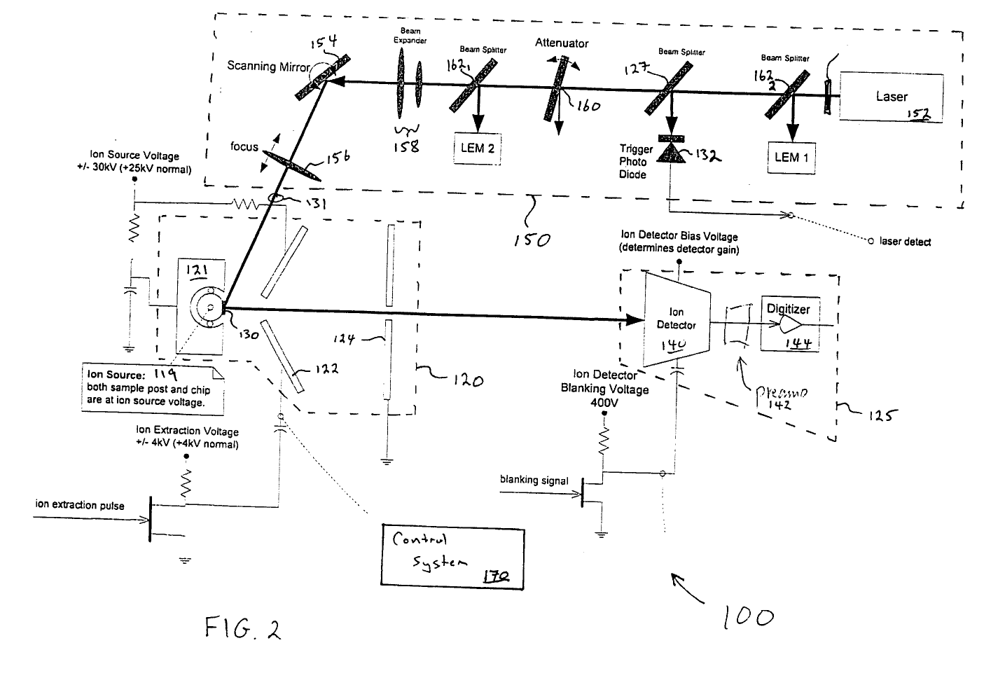

FIG. 2 illustrates a schematic view of components of a laser desorption and ionization, time-of-flight (LDI-TOF) mass spectrometer device 100 according to one embodiment of the present invention. Briefly, mass spectrometer device 100 includes ion optics system 120, ion detection system 125, light optics system 150 and control system 170.

As shown, ion optics system 120 includes a repeller lens 121, an extractor plate 122 and an acceleration lens 124. A mass filter (not shown) may be included, and would typically be positioned between the acceleration lens 124 and the detection system 125. As shown, extractor 122 is conical in shape and acceleration lens 124 is planar, however, other geometries may be used as desired. For example, both extractor 122 and acceleration lens 124 may be planar. Both extractor 122 and acceleration lens 124 have apertures which together define a flight path for ions desorbed from sample 130. A flight tube (not shown) or other enclosure encloses the ion optics system, the detection system, and the flight path between the ion optics system 120 and the detection system 125. Typically this enclosure is evacuated so as to prevent unwanted interactions during flight of the ions.

Detection system 125 includes an ion detector 140 and a digitizer module 144. Ion detector 140 detects ions desorbed from sample 130 and produces a signal representing the detected ion flux. Examples of suitable detection elements include electron multiplier devices, other charge-based detectors, and bolometric detectors. Examples include discrete and continuous dynode electron multipliers. Digitizer 144 converts an analog signal from the detector to a digital form, e.g., using an analog-to-digital converter (ADC). A pre-amplifier 142 may be included for conditioning the signal from the ion detector 140 before it is digitized.

Mass spectrometer device 100 also includes a light optics system 150 that includes a light source 152. Light optics system 150 is designed to produce and deliver light to the sample 130. In preferred aspects, optics system 150 includes a plurality of optical elements that may condition, redirect and focus the light as desired so that light of known energy, and focus, is delivered to the sample 130. Light source 152 preferably includes a laser, however, other light producing elements may be used, such an arc lamp or flash tube (e.g., xenon). The delivered light is preferably provided as one or more pulses of known duration, intensity and period. Thus, in preferred aspects, light system 150 generates and delivers pulsed laser light to sample 130.

Suitable laser based light sources include solid state lasers, gas lasers and others. In general, the optimum laser source may be dictated by the particular wavelength(s) desired. Generally, the desired wavelengths will range from the ultraviolet spectrum (e.g., 250 nm or smaller) through the visible spectrum (e.g., 350 nm to 650 nm) and into the infrared (e.g., 1,000 nm) and far infrared. The light source may include a pulsed laser or a continuous (cw) laser with other pulse generating elements. Pulse generating elements may also appear in the light optics system downstream of the light source. For example, a continuous light source may be chopped to generate pulses just before the light impinges on the sample. Examples of suitable lasers include nitrogen lasers; excimer lasers; Nd:YAG (e.g., frequency doubled, tripled, quadrupled) lasers; ER:YAG lasers; Carbon Dioxide (CO₂) lasers; HeNe lasers; ruby lasers; optical parametric oscillator lasers; tunable dye lasers; excimer, pumped dye lasers; semiconductor lasers; free electron lasers; and others as would be readily apparent to one skilled in the art.

In the embodiment shown in FIG. 2, light optics system 150 also includes pulse directing element 154 and focusing element 156. Additional useful optical elements include beam expander lens set 158, attenuator element 160, beam splitter 127 and one or more additional beam splitting elements 162. Pulse directing element 154 is configured to direct the light pulse 131 from source 152 toward sample 130. In one aspect, light directing element 154 includes a mirror configured to raster the pulses along one or more directions across the sample. However, other sets of one or more reflecting, diffracting, or refracting elements may be used. Focusing element 156 operates to adjust the focus of the light pulse 131 to obtain a desired spot size and shape at the intersection of the light pulse 131 and the sample 130. For example, focusing element 156 may focus the pulse to a circular spot or an elliptical spot of a desired size.

Optional beam expanding lens set 158 is provided to expand the pulses to facilitate focusing to a small spot size. Attenuator element 160, also optional, may be used to condition the intensity of the pulses or a portion of the pulses. Suitable attenuation elements include fixed or variable neutral density filters, interference filters, a filter wheel, apertures, and diffusing elements. Beam splitter element 127 is included to provide a portion of each pulse to an optical detection element 132. Optical detection element 132 may include a photosensor and associated circuitry to convert detected light into an electrical signal. For example, in one embodiment, element 132 includes a trigger photo diode that detects the light pulse and generates a signal that is used by control system 170 for timing purposes, such as for timing the generation of an extraction field in ion optics system 120 and for timing the rastering of the light pulses across the sample 130.

Optional beam splitting elements 162 are useful for determining output characteristics of the laser source 152. For example, beam splitter 1622 may provide a portion of the pulse to a photosensor circuit element to determine whether a laser pulse has an anomalously high or low laser energy so that the spectrum generated due to that pulse may be rejected. Beam splitter 162, (and associated photosensor element) may provide a measurement of the pulse characteristics after conditioning by attenuator 160. For example, a comparison of signals from beam splitter elements 162, and 1622 can be used to generate a signal to control an adjustable attenuator element 160 to reduce or increase the pulse attenuation as desired or otherwise condition the pulses as desired. Such a system can also be used to provide feedback for controlling light source 152, for example, to correct for long term drift in the energy of pulses generated by a pulsed laser.

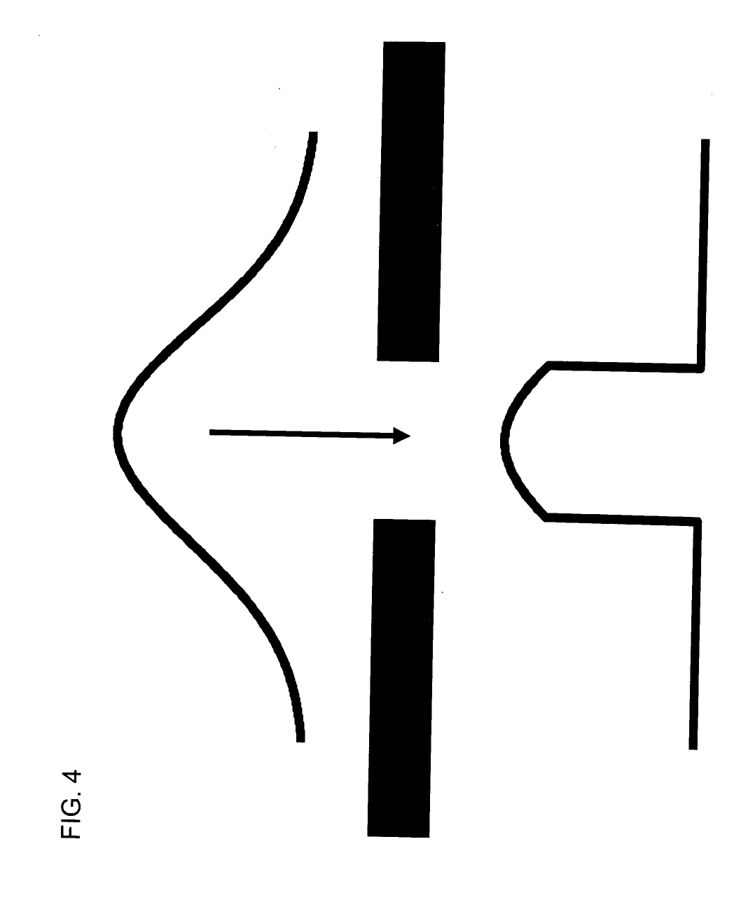

In one embodiment, light optics system 150 includes a mask element configured to mask a portion of each light pulse, so that only a desired portion of the pulse impinges on sample 130. For example, a physical mask element may include an aperture positioned and sized so as to mask off an undesired portion of the light pulse. The size of the aperture may be adjustable. In this manner, as shown in FIG. 4, a more uniform intensity portion of each pulse is allowed to pass while rejecting the remaining portion of the pulse. Such a mask element may be positioned as desired along the path of the light pulses. In one aspect, however, it is desirable to use feedback to controllably adjust the position of the aperture and the size of the aperture of the mask element. For example, one or both of beam splitter elements 162 may be used to provide a pulse profile to a detection element (e.g., photosensor, CCD array, etc.) to provide a feedback signal. Based on the pulse profile provided in the feedback signal, control system 170 may adjust the position of the aperture of the masking element to optimize the pulse profile allowed to pass. For example, in one aspect, it is desirable to allow a portion of the pulse having a substantially uniform intensity profile to pass.

It should be appreciated that alternate or additional optical elements may be used for conditioning the light pulses as desired. It should also be appreciated that alternate configurations of the various optical elements of optics system 150 are within the scope of the present invention.

Returning to the ion optics system 120 shown in FIG. 2, repeller 121 is preferably configured to receive a probe interface 119. Probe interface 119 is itself configured to engage a probe so that illumination (e.g., laser illumination) from the light optics system 150 illuminates a sample presenting surface on the probe. The sample presenting surface, as shown in FIG. 2, may include sample 130 deposited or otherwise formed thereon. A probe may include one or multiple sample presenting surfaces. Probe interface 119 is preferably designed to be in electrical contact with repeller 121 so that the probe interface 119, the probe, and the repeller 121 together act as a repeller.

In one embodiment, probe interface 119 is configured to translate the probe, and therefore the sample presenting surface, along at least one direction. For example, as shown in FIG. 2, the probe interface 119 may be configured to translate the probe in the z-direction, where the plane of FIG. 2 represents the x- and y-directions. For example, probe interface 119 may include, or be coupled to, a stepper motor or other element configured to translate the probe in a controllable manner. In response to a control signal received from a control system (not shown), the stepper motor moves the probe along the z-direction. It should be appreciated that other probe translation mechanisms may be used. For example, these might include servo, voice coil, and piezoelectric drive mechanisms.

In one embodiment, pulse directing element 154 is configured to raster the light pulses across the sample presenting surface, and therefore across sample 130 deposited or formed thereon. For example, as shown in the embodiment of FIG. 2, pulse directing element 154 is configured to move the pulses across the sample presenting surface in a second direction that is substantially perpendicular to the direction of translation of the probe interface. As shown, the second direction is within the plane of FIG. 2 (i.e., x-y plane). In one embodiment, pulse directing element 154 includes a movable mirror element for adjusting the position where the light pulse intersects the sample presenting surface along the second direction. In response to a control signal received from control system 170, the mirror rotates around an axis so as to move the pulses along the second direction. Movement of the mirror may be discrete or continuous both spatially and temporally. A stepper motor coupled to the mirror element may be used. It should be appreciated that other pulse directing mechanisms may be used. For example, these might include other sets of reflecting, diffracting, or refracting elements. These elements might be driven mechanically (for example, a tilting mirror) or electrically (for example, electro-optical or acousto-optical devices).

Together, the probe translation mechanism and the pulse directing mechanism operate under the control of control system 170 to automatically raster the light pulses across the sample presenting surface so as to create a two dimensional illumination pattern thereon. In one aspect, the pulse directing mechanism may be controlled to move the path of the pulses as the pulses are occurring. Similarly, the probe translation mechanism may be controlled to move the probe as the pulses are occurring. In another aspect, the pulse directing mechanism may be controlled to move the pulse path after one or more pulses. Similarly, the probe translation mechanism may be controlled to move the probe after one or more pulses. The pulse directing mechanism and the probe translation mechanism may be controlled to operate simultaneously, or separately.

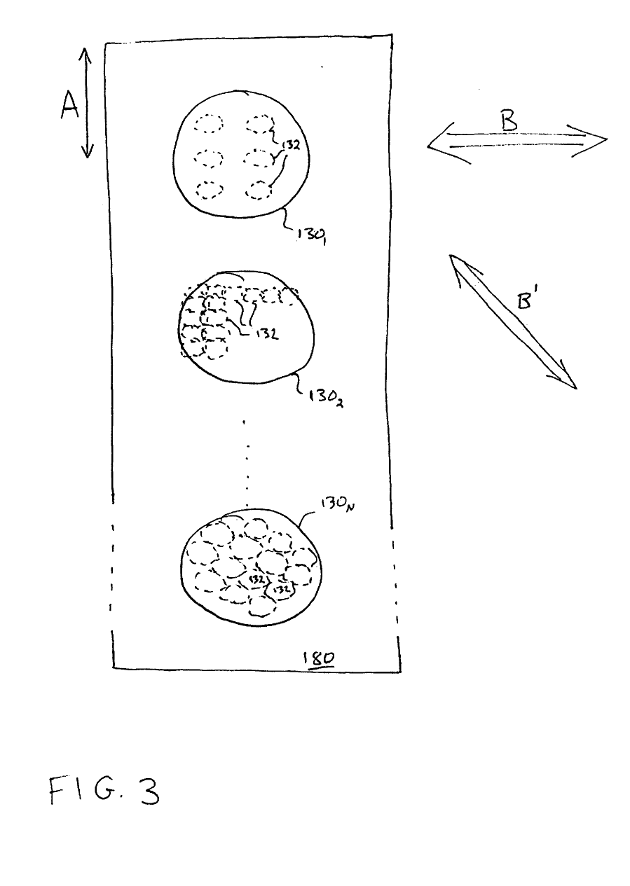

FIG. 3 illustrates examples of possible raster patterns according to the present invention. As shown, probe 180 includes multiple sample presenting regions 130. One example of such a probe is the ProteinChip® array from Ciphergen Biosystems, Inc., assignee of the present invention. The ProteinChip array provides multiple sample presenting regions similar to those shown in FIG. 3. As shown, translation of the probe by the probe interface translation mechanism moves the probe along the direction indicated by “A” in FIG. 3. Similarly, rastering of the pulses across the sample presenting surfaces by the pulse directing mechanism occurs in the “B” direction. As shown the “A” and “B” directions are substantially perpendicular. However, depending in part on the configuration of the light optics system 150, the direction of light pulse rastering may be in any direction over the sample presenting surface. For example, the systems may be configured such that pulse directing element 154 rasters the light pulses along the “B′” direction. As another example, it is possible, although not necessarily useful, that pulse directing element 154 be configured to raster the light pulses along the “A” direction. In general, it is preferred that the probe translation and pulse deflection directions be non-parallel, and more preferred that they be substantially orthogonal. It is also preferred that scanning the light pulses across the sample be done in a manner such that the distance to the sample and the angle of incidence change as little as possible. For example, it is preferred that the light pulses be scanned across the sample substantially perpendicular to the plane defined by the incident path of the pulses and the normal of the sample presenting surface. In this manner, the change in the angle of incidence, if any, when scanning will be minimal, as will the variation in the dimensions of the illuminated area. It should also be appreciated that the sample presenting surface need not be flat, the motion of the sample presenting surface need not be linear, nor must the scanning of the light pulses across the sample presenting surface be linear.

In FIG. 3, one simple raster pattern is shown on sample presenting region 130₁. Here, the illumination spots or areas 132 are separated, lie entirely within the sample presenting region, do not overlap, and are arranged in a square raster pattern. A portion of another raster pattern is shown in sample presenting region 130₂ of FIG. 3. Here, the illumination areas 132 overlap, and some of the illumination areas have a portion that is outside the sample presenting region. Another raster pattern is shown in sample presenting region 130_{N}. In the oblique array shown here, the illumination spots 132 do not overlap, but are substantially contiguous. It should therefore be appreciated that an entire sample presenting region may be illuminated by a raster pattern comprising a plurality of overlapping illumination areas 132, or that a portion of a sample presenting region may be illuminated by a raster pattern comprising a plurality of overlapping or non-overlapping illumination areas 132. Further, it should be appreciated that two or more different raster patterns may be illuminated on a single sample presenting region. In general, any desired raster pattern or combination of raster patterns may be implemented by a raster algorithm according to the present invention.

In one embodiment, the ions desorbed from a sample by each illumination spot or area 132 in a raster pattern are detected by detector 140 and the detected ion flux as a function of time is used to generate a mass spectrum of the desorbed ions. The spectra generated for a plurality of illumination areas are combined, in one aspect, to form a combined spectrum representing the entire raster pattern or a portion of the raster pattern. In preferred aspects, forming a combined spectrum is performed after digitization of the component spectra.

The raster algorithm and control logic may be provided to control system 170 using a any means of communicating such logic, e.g., via a computer network, via a keyboard, mouse, or other input device, on a portable medium such as a CD, DVD, or floppy disk, or on a hard-wired medium such as a RAM, ROM, ASIC or other similar device. Control system 170 may include a stand alone computer system and/or an integrated intelligence module, such as a microprocessor, and associated interface circuitry for interfacing with the various systems of mass spectrometer device 100 as would be apparent to one skilled in the art. For example, control system 170 preferably includes interface circuitry for providing control signals to the pulse directing element and probe translation mechanism to control the generation of a raster pattern of light pulses on the sample presenting surface, and also to focusing element 156 to adjust the focus of the light pulses. Also, control system 170 preferably includes circuitry for receiving trigger signals from photo diode element 132, generating timing signals and for providing timing control signals to the ion optics system (e.g., ion extraction pulse signal) and to the detection system 125 (e.g., for a blanking signal).

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A mass spectrometer device, comprising:
an illumination source that provides light pulses;
a probe interface configured to engage a probe so that the light pulses illuminate an illumination area on a sample presenting surface on the probe, the probe interface including probe translation means for automatically translating an engaged probe such that the illumination area moves across the sample presenting surface along a first direction; and
pulse directing means for directing the light pulses to the sample presenting surface and for automatically redirecting the light pulses across the sample presenting surface in a second direction, wherein the second direction is non-parallel to the first direction,
wherein the probe translation means and the pulse directing means operate to raster the illumination area in a two-dimensional, illumination pattern across the sample presenting surface.

2. The device of claim 1, wherein the pulse directing means includes a movable mirror element.

3. The device of claim 1, wherein the probe translation means includes a stepper motor.

4. The device of claim 1, further comprising control means for controlling the probe translation means to translate the probe such that the illumination area moves across the sample presenting surface in the first direction, and for controlling the pulse directing means to redirect the light pulses in the second direction.

5. The device of claim 4, wherein the control means controls the probe translation means and the pulse directing means to translate the probe and redirect the light pulses, respectively, at different times so as to form the two dimensional illumination pattern on the sample presenting surface.

6. The device of claim 1, wherein the illumination source includes means for conditioning the light pulses such that each pulse has a substantially uniform intensity profile upon intersecting the sample presenting surface.

7. The device of claim 6, wherein the conditioning means includes an element selected from the group consisting of a) a mask for masking a portion of the light pulses, b) pulse focusing optics, c) fiber optic elements, d) a spatial filter and e) a diffusing element.

8. The device of claim 1, wherein the two dimensional illumination pattern comprises one of a single pattern, multiple intersecting patterns and multiple non-intersecting patterns.

9. The device of claim 1, wherein the illumination source provides a plurality of pulses.

10. The device of claim 9, wherein one or both of the probe translation means and the pulse directing means translate the probe and redirect the light pulses, respectively, after one or more light pulses.

11. The device of claim 1, further comprising a means for generating spectra from each illuminated area in the illumination pattern on the sample presenting surface, and for combining the spectra from each illuminated area of the sample presenting surface to form a combined spectrum for an illuminated region of the sample presenting surface.

12. The device of claim 1, wherein the illumination source includes one of a laser and a pulsed laser.

13. A method of illuminating a region of a sample in a mass spectrometer with one or more light pulses; comprising:
providing light pulses;
providing a probe interface configured to engage a probe;
directing the light pulses towards a sample presenting surface on an engaged probe, wherein the light pulses illuminate an illumination area of the sample presenting surface; and
forming a two dimensional illumination pattern on a region of the sample presenting surface by:
automatically translating the probe such that the illumination area moves across the sample presenting surface in a first direction; and
automatically redirecting the light pulses in a second direction across the sample presenting surface, wherein the second direction is non-parallel to the first direction.

14. The method of claim 13, wherein the illumination source provides a plurality of pulses.

15. The method of claim 14, wherein one or both of automatically translating and automatically redirecting are performed after one or more pulses.

16. The method of claim 13, wherein automatically translating and automatically redirecting are performed substantially simultaneously.

17. The method of claim 13, wherein automatically translating includes stepping the probe interface in the first direction using a stepper motor.

18. The method of claim 13, wherein directing the light pulses includes positioning a movable mirror element such that the light pulses are scanned across the sample presenting surface.

19. The method of claim 18, wherein automatically redirecting includes automatically moving the mirror element such that the light pulses are redirected across the sample presenting surface in the second direction.

20. The method of claim 13, wherein the illumination source includes a laser and wherein the light pulses are laser pulses.

21. The method of claim 13, further including:
generating spectra for each illuminated area of the sample presenting surface in the two dimensional illumination pattern; and
combining the spectra from each illuminated area of the sample presenting surface to form a combined spectrum for the illuminated region of the sample presenting surface.

22. The method of claim 13, further comprising masking a portion of the light pulses such that each light pulse has a substantially uniform intensity profile upon intersecting the sample presenting surface.

23. The method of claim 13, wherein the two dimensional illumination pattern comprises one of a single pattern, multiple intersecting patterns and multiple non-intersecting patterns.

24. A mass spectrometer device, comprising:
an illumination source that provides light pulses;
a probe interface configured to engage a probe so that the light pulses illuminate an illumination area on a sample presenting surface on the probe, said probe interface further being configured to automatically translate an engaged probe responsive to a first control signal such that the illumination area moves across the sample presenting surface along a first direction;
a pulse directing element configured to direct the light pulses to the sample presenting surface and to automatically redirect the light pulses along a second direction non-parallel to the first direction in response to a second control signal; and
a control module configured to provide the first and second control signals so as to raster the illumination area in a two dimensional illumination pattern on a region of the sample presenting surface.

25. The device of claim 24, further including:
a detection module configured to generate spectra from each illuminated area in the illumination pattern on the sample presenting surface; and
a processor, coupled to the detection module, configured to combine the spectra generated from each illuminated area of the sample presenting surface to form a combined spectrum for the illuminated region of the sample presenting surface.

26. The device of claim 24, further including a masking element configured to mask a portion of the light pulses such that each pulse has a substantially uniform intensity profile upon intersecting the sample presenting surface.

27. The device of claim 24, wherein the probe interface includes a stepper motor for translating the probe along the first direction.

28. The device of claim 24, wherein the pulse directing element includes a movable mirror element.

29. The device of claim 24, wherein the illumination source comprises one of a laser and a pulsed laser.

30. The device of claim 24, wherein the illumination source provides a plurality of pulses.

31. The device of claim 30, wherein the control module provides one or both of the first and second control signals after one or more illumination pulses.

32. The device of claim 24, wherein the two dimensional illumination pattern comprises one of a single sequential pattern, multiple intersecting patterns and multiple non-intersecting patterns.

33. The device of claim 24, wherein the first direction is substantially perpendicular to the second direction.

34. The device of claim 1, wherein the first direction is substantially perpendicular to the second direction.

35. The device of claim 9, wherein one or both of the probe translation means and the pulse directing means operate while the illumination pulses are occurring.

36. The method of claim 13, wherein the first direction is substantially perpendicular to the second direction.
